(19) United States
(12) Patent Application Publication
(10) Pub. No.: US 2002/0171953 A1
(43) Pub. Date: Nov. 21, 2002

(54) Optical switch with vertically-aligned mirrors

(76) Inventor: Tsung-Yi Yang, Rolling Heights, CA (US)

Correspondence Address: ELLIOTT N. KRAMSKY, Esq., Suite 400, 5850 Canoga Avenue, Woodland Hills, CA, 91367, US

(21) Appl. No.: 09/862,147

(22) Filed: May 21, 2001

(51) Int. Cl. G02B 5/08

(52) U.S. Cl. 359/877; 359/871; 359/838

(57) ABSTRACT

An optical switch includes a plurality of beam directing elements. Each of the beam directing elements includes a mirror that is hinged vertically within a housing so that the attitude of the mirror is angularly adjustable within the horizontal plane of the housing. At least one input port is provided for receiving an input light beam while a plurality of output ports is provided with each being associated with one of the mirrors. A hook is provided for coupling each mirror to a mirror driver that is selectively-energizable by a controller.

### BACKGROUND

1Field of the Invention

The present invention relates to photonic switches. More particularly, this invention pertains to a mechanical switch suitable for incorporation into optical switching arrays.

2Description of the Prior Art

The two primary operational modes of switching signals in an optical network are OEO (optical-electrical-optical) and photonic. They differ in that the switching function is accomplished electronically in the OEO mode while photonic switching is accomplished by the deflection of beams. Such beam deflections may be occasioned by numerous means, the most prominent of which utilizes MEMS (microelectromechanical systems) technology.

In a MEMS system, switching is accomplished by the use of mirrors whose orientations are responsive to control signals. Often a plurality of mirrors is arranged within a switching module architecture having a plurality of input and output ports. Numerous switching modules may, in turn, be grouped or cascaded together to form large switches. Examples of switching architectures include crossbar switches, Benes switches, Spanke-Benes switches and Spanke switches.

The MEMS switches that comprise switching architectures generally comprise pluralities of planar mirrors, each mirror being hinged at its bottom edge to rotate upwardly and downwardly to a preferred attitude to either intercept and redirect an input beam or to permit the beam to bypass its position without effect. The light passes through the switch in a plane that is parallel to the bottom surface of a switch housing.

Movements of the mirror switches between preferred orientations are responsive to electromechanical forces. The application of such forces requires intimate contact between the mirror surface and a powered mechanism, such as a solenoid-actuated ram. As the mirrors are hinged to the bottom of the switch housing, the weight of the individual mirror will necessarily act against the ram reflecting the force of gravity. Over time, this may lead to some deformation of the mirror. Even minute deformation of a mirror surface may result in unreliable switch operation. A deformed mirror cannot be depended upon to redirect an input beam to an output port with sufficient accuracy to assure that a significant portion of the input signal is detected at the associated output port.

### SUMMARY OF THE INVENTION

The preceding and other shortcomings of the prior art are addressed by the present invention that provides, in a first aspect, an optical switch. The switch includes a plurality of mirrors, each of which includes a reflective surface portion.

Each of the mirrors has an associated elongated hinge. The hinge lies within a plane that includes at least a portion of the reflective portion of the mirror. Each mirror hinge is substantially-vertically oriented.

The mirrors are arranged into at least one row. A selectively-actuable mirror driver is coupled to each of the mirrors and a controller is provided for selectively energizing the plurality of mirror drivers whereby the attitudes of the mirrors are responsive to the controller.

In a second aspect, the invention provides a beam directing element for an optical switch. Such element includes a mirror that includes a reflective surface portion. The mirror has an associated elongated hinge that is within a plane that includes at least a portion of the reflective surface portion of the mirror. A selectively-actuable mirror driver is coupled to the mirror and a controller is provided for selectively energizing the driver to control the attitude of the mirror.

In a third aspect, the invention provides an Such switch includes a housing. A plurality of mirrors is arranged within the housing. Each of such mirrors has an associated elongated hinge.

Each of the mirrors is fixed within the housing at the associated hinge. The mirrors are arranged within the housing into at least one row.

The housing has at least one port for receiving an input optical beam and a plurality of output ports, each output port being aligned with one of said plurality of mirrors. A selectively-actuable mirror driver is coupled to each of the mirrors and a controller is provided for selectively energizing the plurality of mirror drivers whereby the attitudes of the mirrors are responsive to the controller.

In a second aspect, the invention provides a beam directing element for an optical switch. The element includes a planar mirror. The mirror is generally rectangular and has an associated hinge. The hinge is coincident with a side edge of the mirror. A selectively-actuable ram is coupled to the mirror and a controller is provided for selectively energizing the ram to control the attitude of the mirror.

In a third aspect, the invention provides an optical switch. Such switch includes a housing. A plurality of mirrors is arranged within the housing. Each of the mirrors includes a reflective surface portion and has an associated hinge that is within a plane that includes at least a portion of the reflective surface portion of the mirror.

The hinges of each of the mirrors are fixed substantially vertical within the housing and are arranged into at least one row. The housing has at least one port for receiving an input beam and a plurality of outport ports, each aligned with one of the plurality of mirrors.

A selectively-actuable mirror driver is coupled to each of the mirrors and a controller is provided for selectively energizing the plurality of mirror drivers whereby the attitudes of the mirrors are responsive to the controller.

The foregoing and additional features of the invention will become further apparent from the detailed description that follows. Such description is accompanied by a set of drawing figures in which numerals, corresponding to those of the written description, point to the features of the invention. Like numerals refer to like features throughout both the written description and the drawing figures.

### BRIEF DESCRIPTION OF THE DRAWINGS

Figures 1(a) and 1(b) and 1(c) are top plan views of a beam directing element for an optical switch in accordance with alternative embodiments of the invention;

FIGS. 2(a) and 2(b) are enlarged partial views taken at lines 2(a) and 2(b) of Figures 1(a) and 1(b) respectively for illustrating the attachment of a mirror to a mirror driver in accordance with the invention;

FIG. 3 is a top plan view of a 1×8 optical switch in accordance with the invention; and

FIG. 4 is a side elevation, in cross-section, of an optical switch in accordance with the invention taken at line 4-4 of FIG. 3.

### DETAILED DESCRIPTION OF THE PREFERRED EMBODIMENT

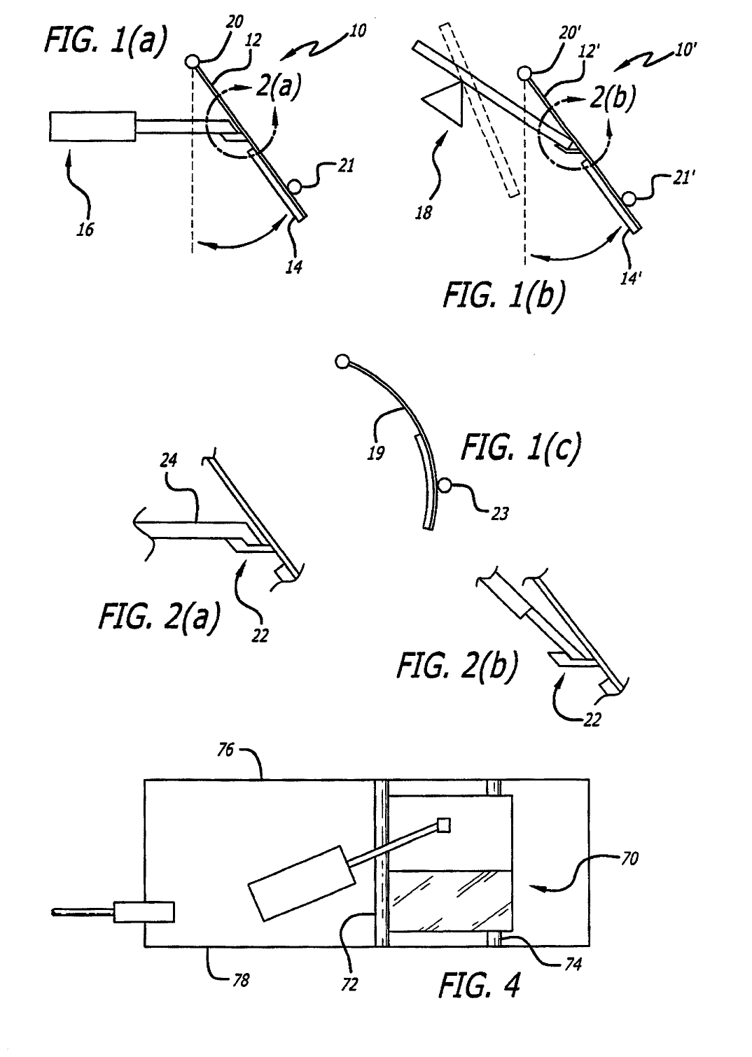

Figures 1(a) and 1(b) are top plan views of a beam directing element 10, 10′ for an optical switch in accordance with alternative embodiments of the invention. Corresponding elements of the two embodiments are indicated by primed numeral.

The element 10, 10′ includes a mirror 12, 12′ having a surface with at least a portion thereof comprising a reflective coating 14, 14′. The element 10, 10′ is arranged for mounting within a switch so that the weight of the mirror 12, 12′ does not act against an electromechanical mirror driver, such as the ram end of a solenoid 16 according to the embodiment of FIG. 1(a) or the armature of a relay 18 according to the embodiment of FIG. 1(b). By preventing such an interaction that, over time, may warp the mirror, the invention provides a switch that is more reliable, and less subject to mirror replacement, than switches that employ mirrors hinged for upward and downward angular movements into and out of the path of an input light beam.

A hinge 20, 20′ is coincident with an edge of the mirror 12, 12′. Movement of the mirror 12, 12′ (which needn't be planar) about the hinge 20, 20′ is occasioned by the action of an energizable electromechanical mirror driver, such as the solenoid 16 or the relay 18, that is positioned to abut the surface of the mirror 12, 12′ a distance remote from the hinge 20, 20′. Such movement is limited by means of stops 21, 21′.

The present invention is also suitable for use with a mirror having curvature. FIG. 1(c) is a top plan view of such a mirror 19 that has been acuated (by means of an appropriate mirror driver) to its reflective position whereby it abuts an associated stop 23.

As illustrated in FIGS. 2(a) and 2(b), enlarged partial views of the device taken at lines 2(a) and 2(b) of FIG. 1(a) and 1(b) respectively, the reactive portion of the solenoid 16, relay 18 or like device (i.e., the portion that contacts the mirror 12, 12′) is joined to the surface of the mirror 12, 12′ by means of a hook 22 which interacts with the ram end 24 of the solenoid 16 (FIG. 2(a)) or with the armature of a relay 18.

The hook 22 is provided to assure that the angular orientation of the mirror 12 with respect to an input light beam is adjustable in both clockwise and counterclockwise directions about the hinge 20 in response to the state of the energizable mirror driver. This reflects the fact that gravity cannot be relied upon to bias the position of the mirror 12, 12′ downwardly in switch arrangement employing a beam deflection apparatus in accordance with the invention.

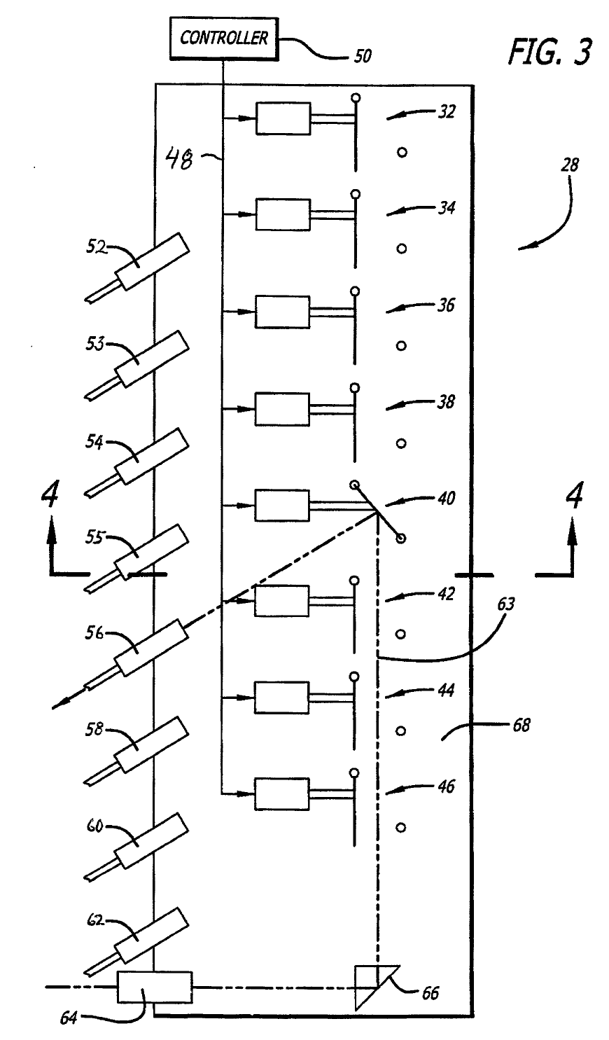

FIG. 3 is a top plan view of a 1×8 optical switch 28 that employs a plurality of beam deflection devices in accordance with the invention. While the beam deflection devices of the switch utilize solenoid mirror drivers, it will be appreciated that a like switch may be alternatively configured employing relays in the stead of solenoids. As a further alternative, it shall be understood that such a switch could comprise a combination of solenoids and relays as mirror drivers.

The mechanisms of the switch 28 are contained within a housing 30. As mentioned earlier, each of beam deflection elements 32 through 46 is fixed within the housing 30 so that its hinge axis is vertical. The solenoids associated with the elements 32 through 46 each receive an electrical input from an output bus 48 of a controller 50. The controller generates an electrical output that energizes the solenoids of the elements 32 through 46 to executed a desired switching sequence so that optical signals are selectively applied to a plurality of switch output ports 52 through 62, each output port comprising a collimator and output fiber fixed at an appropriate angle to intercept a beam reflected from an associated beam deflection element with the mirror of the element rotated by an associated mirror driver to the mirror stop.

As shown in FIG. 3, only the mirror of the beam deflection element 40 has been rotated by the associated solenoid in response to a signal from the controller 50. When deflected, the mirror intercepts an input beam 63 that entered the switch 28 20 at an input port 64 and was deflected at a relay prism 66 to travel through the housing 30 in a path parallel to the bottom surface 68 of the housing 30. The other beam deflection elements have no effect upon the path of travel of the input beam 63.

FIG. 4 is a cross-sectional elevation view of the optical switch of the invention taken at line 4-4 of FIG. 3. As can be seen, the mirror 70 of the optical switch 40 is mounted vertically within the housing 30 at its vertically-oriented hinge 72. The stop 74 can also be seen to be mounted vertically within the housing 30 with its ends affixed to spaced top and bottom panels 76 and 78 of the housing 30.

Thus it is seen that the present invention provides an improved optical switch and beam deflection element therefor. By employing the teachings of this invention, one may obtain improved photonic switching in which mirror elements of an optical switch are free from deformation caused by the force of the weight of the mirror upon a mirror driver that must necessarily contact the mirror whether energized or not. In the present invention, the arrangement of beam deflection elements with hinged axes of rotation vertical to permit the associated mirrors to swing in a horizontal plane reduces the stressing of the sensitive mirrors and thereby enhances the life and reliability of optical switches incorporating beam deflection elements in accordance with the invention. By providing an arrangement in which the weight of the mirror does not act against the operative element of a mirror driver, beam deflection elements and optical switches in accordance with the invention are more rapidly responsive to input (electrical) switching signals and thereby capable of higher optical switching speeds.

While this invention has been described with reference to its presently-preferred embodiments, it is not limited thereto. Rather, the invention is only limited insofar as it is defined by the following set of patent claims and includes within its scope all equivalents thereof.

What is claimed is:

1. An optical switch comprising, in combination:
a) a plurality of mirrors, each of said mirrors including a reflective surface portion;
b) each of said mirrors having an associated elongated hinge, said hinge being within a plane including at least a portion of the reflective surface portion of said mirror;
c) the hinges of each of said mirrors being substantially vertical;
d) said mirrors being arranged into at least one row;
e) a selectively-actuable mirror driver being coupled to each of said mirrors; and
f ) a controller for selectively energizing said plurality of mirror drivers whereby the attitudes of said mirrors are responsive to said controller.

2. An optical switch as defined in claim 1 further including a hook for connecting said mirror driver to said mirror.

3. An optical switch as defined in claim 2 further including a stop associated with each of said mirrors defining the limits of travel of said mirrors.

4. An optical switch as defined in claim 3 wherein at least one of said mirrors is planar.

5. An optical switch as defined in claim 3 wherein at least one of said mirrors includes curvature.

6. An optical switch as defined in claim 3 wherein at least one of said mirror drivers is a solenoid.

7. An optical switch as defined in claim 3 wherein at least one of said mirror drivers is a relay.

8. An optical switch as defined in claim 1 further including:
a) at least one port for receiving an input optical beam;
b) a plurality of output ports; and
c) each of said output ports being aligned with one of said mirrors.

9. An optical switch as defined in claim 1 wherein said mirrors are arranged within a housing.

10. An optical switch as defined in claim 9 wherein said housing includes horizontal spaced top and bottom panels.

11. An optical switch as defined in claim 10 wherein the opposed ends of said hinges are fixed to the inner sides of said top and bottom panels.

12. A beam directing element for an optical switch comprising, in combination:
a) a mirror including a reflective surface portion;
b) said mirror having an associated elongated hinge, said hinge being within a plane including at least a portion of the reflective surface portion of said mirror;
c) a selectively-actuable mirror driver coupled to said mirror; and
d) a controller for selectively energizing said mirror driver to control the attitude of said mirror.

13. A beam directing element as defined in claim 12 further including a hook for connecting said mirror driver to said mirror.

14. A beam directing element as defined in claim 13 further including a stop associated with said mirror defining the limit of travel of said mirror.

15. A beam directing element as defined in claim 14 wherein said mirror is planar.

16. A beam directing element as defined in claim 14 wherein said mirror includes curvature.

17. A beam directing element as defined in claim 14 wherein said mirror driver is a solenoid.

18. A beam directing element as defined in claim 14 wherein said mirror driver is a relay.

19. An optical switch comprising, in combination:
a) a housing;
b) a plurality of mirrors being arranged within said housing, each of said mirrors including a reflective surface portion;
c) each of said mirrors having an associated elongated hinge, said hinge being within a plane including at least a portion of the reflective surface portion of said mirror;
d) the hinges of each of said mirrors being fixed substantially vertical within said housing;
e) said mirrors being arranged into at least one row within said housing;
f) said housing having at least one port for receiving an input optical beam and a plurality of output ports, each of said output ports being aligned with one of said plurality of mirrors;
g) a selectively-actuable mirror driver being coupled to each of said mirrors; and
h) a controller for selectively energizing said plurality of mirror drivers whereby the attitudes of said mirrors are responsive to said controller.

20. An optical switch as defined in claim 19 further including a hook for connecting said mirror driver to said mirror.

21. An optical switch as defined in claim 20 further including a stop associated with each of said mirrors defining the limits of travel of said mirrors.

22. An optical switch as defined in claim 21 wherein at least one of said mirrors is planar.

23. An optical switch as defined in claim 21 wherein at least one of said mirrors includes curvature.

24. An optical switch as defined in claim 21 wherein at least one of said mirror drivers is a solenoid.

25. An optical switch as defined in claim 21 wherein at least one of said mirror drivers is a relay.

26. An optical switch as defined in claim 19 wherein said housing includes horizontal spaced top and bottom panels.

27. An optical switch as defined in claim 26 wherein the opposed ends of said hinges are fixed to the inner sides of said top and bottom panels.
